(19) United States
(12) Patent Application Publication
(10) Pub. No.: US 2012/0024675 A1
(43) Pub. Date: Feb. 2, 2012

(54) DRIVE ASSEMBLY FOR A PASSENGER CONVEYOR

(76) Inventors: Fred R. Spielman, Somers, CT (US); Detlev Lindemeier, Vienna (AT); Bernward Engelke, Vienna (AT); Ary O. Mello, Farmington, CT (US); Dirk Winkelhake, Bolton, CT (US)

(21) Appl. No.: 13/258,559

(22) PCT Filed: Jun. 12, 2009
(86) PCT No.: PCT/US09/47183

§ 371 Date: Sep. 22, 2011

(51) Int. Cl. B66B 23/02; B65G 23/06

(52) U.S. Cl. 198/834

(57) ABSTRACT

An exemplary drive assembly for a passenger conveyor includes a belt including a plurality of cords at least partially encased in a jacket. A plurality of connecting blocks are secured to the belt longitudinally spaced apart from each other along the belt.

### BACKGROUND

Passenger conveyors such as escalators and moving walkways typically include moving surfaces such as steps that carry passengers between landings at opposite ends of the conveyor. The moving surfaces are propelled by a drive assembly including a motor, a drive sprocket and a step chain. The motor typically causes the drive sprocket to rotate. The step chain is driven by the sprocket. The step chain is secured to the moving surfaces in a manner that results in the desired conveyor operation.

Conventional passenger conveyor drive assemblies present various issues. One issue is noise and vibration associated with step chain linkages moving along the path and interacting with the drive sprocket. Another issue is that step chains typically require lubrication, which introduces materials and maintenance issues. Additionally, typical step chain arrangements require maintenance, which introduces additional expense and inconvenience for building owners.

### SUMMARY

An exemplary drive assembly for a passenger conveyor includes a belt including a plurality of cords at least partially encased in a jacket. A plurality of connecting blocks are secured to the belt longitudinally spaced apart from each other along the belt.

The various features and advantages of the disclosed example will become apparent to those skilled in the art from the following detailed description. The drawings that accompany the detailed description can be briefly described as follows.

### BRIEF DESCRIPTION OF THE DRAWINGS

FIG. 1 illustrates an example passenger conveyor.

FIG. 2 illustrates selected portions of an example passenger conveyor drive assembly.

FIG. 3 illustrates other selected portions of an example passenger conveyor drive assembly.

FIG. 4 is a cross-sectional illustration of an example connecting block and belt configuration.

FIG. 5 is a cross-sectional illustration of another example connecting block and belt configuration.

FIG. 6 is a cross-sectional illustration of another example connecting block and belt configuration.

FIG. 7 is a cross-sectional illustration of another example connecting block and belt configuration.

FIG. 8 is a cross-sectional illustration of another example connecting block and belt configuration.

FIG. 9 is a cross-sectional illustration of another example connecting block and belt configuration.

FIG. 10 is a cross-sectional illustration of another example connecting block and belt configuration.

FIG. 11 is a cross-sectional illustration of another example connecting block and belt configuration.

### DETAILED DESCRIPTION

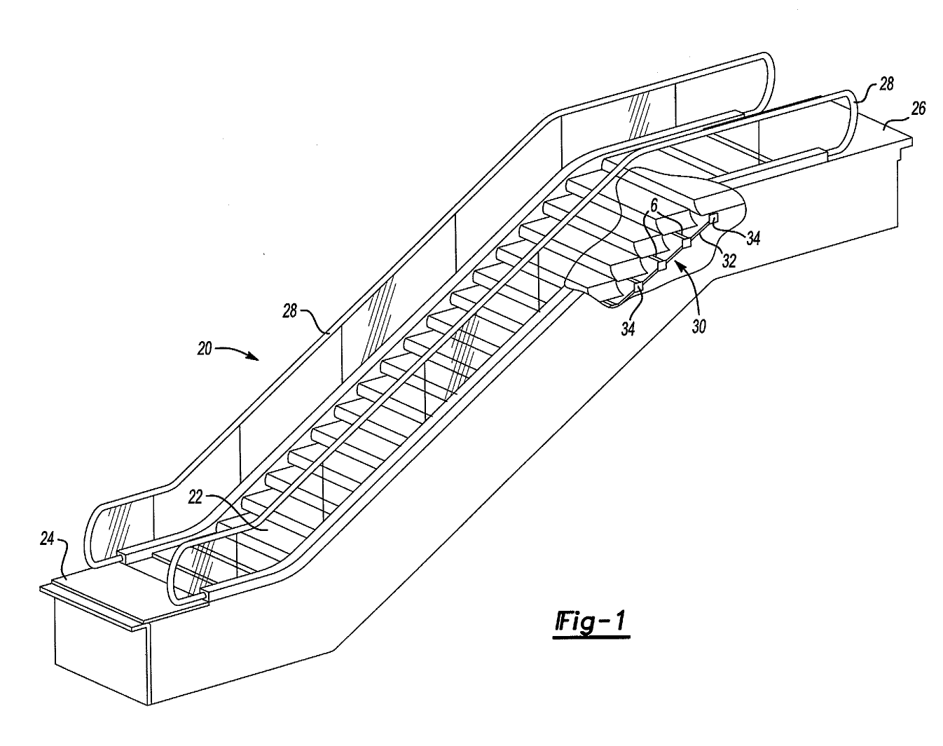

FIG. 1 shows selected portions of an example passenger conveyor 20. The illustrated example conveyor 20 is an escalator. Other examples include moving walkways. The conveyor 20 includes a plurality of moving surfaces 22, which comprise steps in this example. The moving surfaces 22 carry a passenger between landings 24 and 26. A handrail 28 moves with the moving surfaces 22 to provide a surface for an individual to grasp while being carried by the conveyor 20.

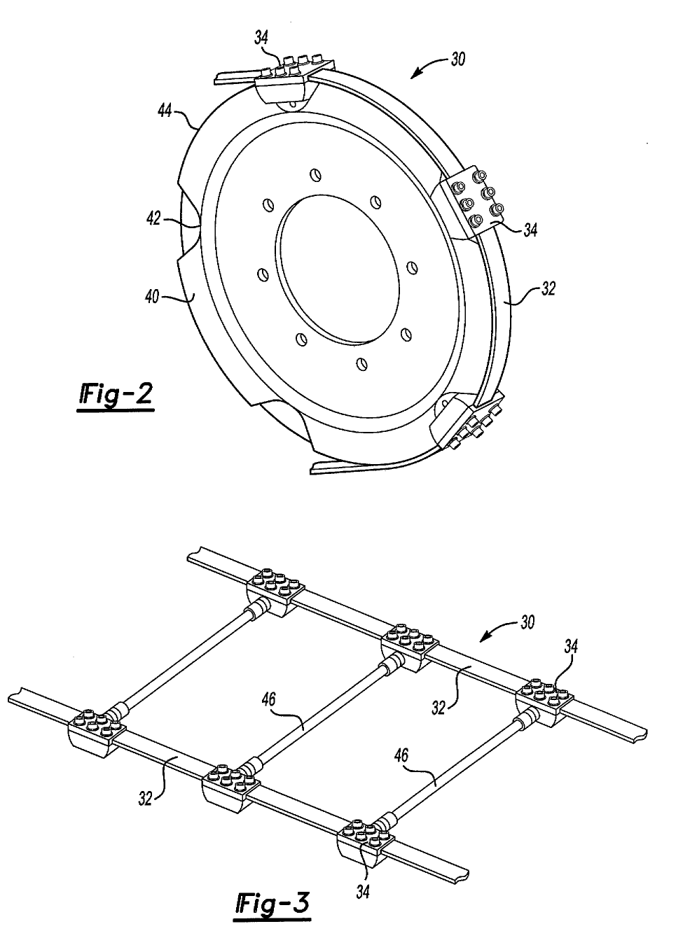

As can be appreciated from FIGS. 1-3, the conveyor 20 includes a drive assembly 30 comprising a belt 32 and a plurality of connecting blocks 34 secured to the belt 32. The connecting blocks 34 are spaced from each other longitudinally along a length of the belt 32.

A drive wheel 40 is rotated by a motor (not illustrated) and imparts a moving force to move the belt 32 and the connecting blocks 34 along a path corresponding to the path followed by the moving surfaces 22. The connecting blocks 34 cooperate with a correspondingly configured surface or features on the drive wheel 40 such that the connecting blocks 34 are positively engaged by the drive wheel 40 to move them and the belt 32. In the illustrated example, the connecting blocks 34 are at least partially received within recesses 42 in the drive wheel 40. In this example, the drive wheel 40 also includes an exterior drive surface 44 that engages the belt 32 directly to propel the belt 32. In this example, frictional engagement between the drive surface 44 and the belt 32 facilitates moving the belt as desired.

The connecting blocks 34 provide a positive driving surface and the belt 32 provides a frictional driving surface for causing desired movement of the belt 32 and the connecting blocks 34. The moving surfaces are coupled with the belt 32 by a connection between the connecting blocks 34 and axles 46 such that movement of the belt 32 and connecting blocks 34 results in corresponding movement of the moving surfaces 22. In this example the connecting blocks 34 have interiorly facing connection surfaces that are configured to be connected to the axles 46. The moving surfaces 22 are connected to the axles 46 using a conventional step-to-axle connection in one example. In another example, the connecting blocks 34 have at least one connection surface configured to be connected directly to a portion of a moving surface 22. The connecting blocks 34 facilitate coupling the moving surfaces 22 to the belt 32 so that the drive assembly 30 can move the moving surfaces 22 as desired.

In the example of FIG. 3, the spacing between the connecting blocks 34 corresponds to the pitch of the axles 46. In another example, not every connecting block is coupled to a moving surface 22 or axle 46. In such an example some of the connecting blocks serve as positive drive elements without providing a connection between the drive assembly 30 and the moving surfaces 22.

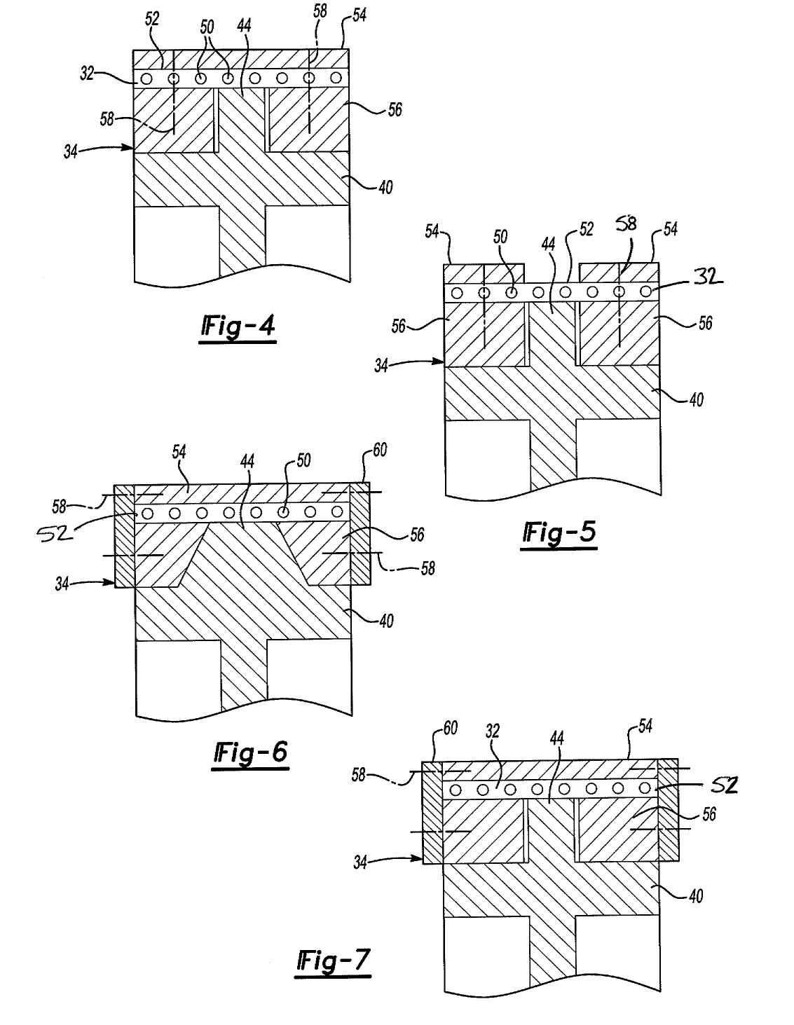

There are various possible configurations of a drive assembly 30 designed according to this invention. One example is shown in FIG. 4. This example includes a belt 32 having a plurality of cords 50 that extend longitudinally along the length of the belt 32. In one example the cords 50 comprise steel. In another example, the cords 50 comprise a polymer. The cords 50 are at least partially covered by a jacket 52. One example jacket material comprises a urethane such as thermoplastic polyurethane.

The connecting blocks 34 in this example include a first portion 54 received against one side of the belt 32 and a second portion 56 received on an oppositely facing side of the belt 32. In this example, there is one first portion 54 and two second portions 56. Securing members 58 hold the connecting blocks 34 in their desired positions on the belt 32. One example includes threaded securing members 58 such as bolts that are received through holes in the belt 32 and are threaded into at least one of the portions 54 or 56.

The connecting blocks in one example comprise metal. One example comprises steel. Some connecting blocks have a polymer coating. Other example connecting blocks comprise hard plastic materials.

FIG. 5 shows another example in which there are two first portions 54 spaced from each other.

FIG. 6 illustrates another variation in which the second portions 56 have an interior surface arranged at an oblique angle relative to an axis of rotation of the drive wheel 40. This example also includes securing block portions 60 that are received against exterior surfaces on the first portion 54 and the second portions 56. The securing members 58 are not received through the belt 32 in this example as can be appreciated from the drawing.

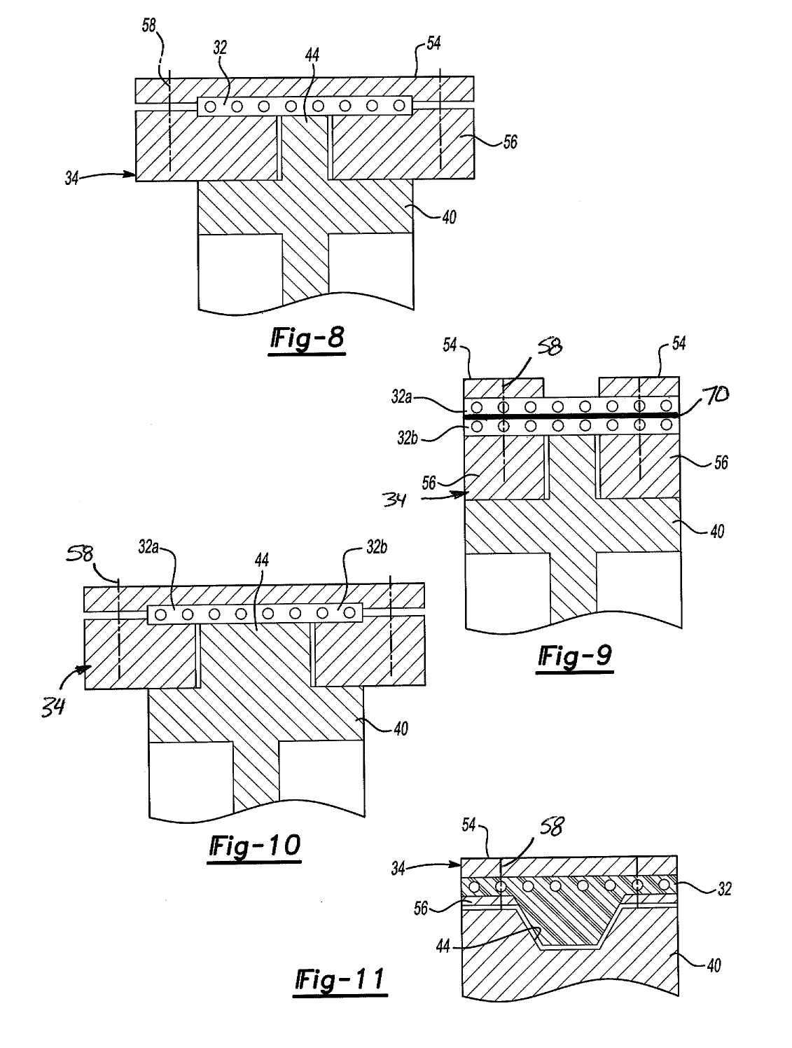

The example of FIG. 7 is similar to that of FIG. 4 but has the additional securing block portions 60 and securing member 58 received on the opposite sides of the belt 32. In FIG. 8 the first portion 54 and the second portions 56 extend laterally outward considerably further than the outside dimension of the jacket 52 of the belt 32. In this embodiment, the securing members 58 are secured to at least one of the portions 54 and 56, but are not received through the belt 32.

FIG. 9 shows another example drive assembly arrangement in which two belts 32A and 32B are included. In this example, a spacer 70 is placed between the belts 32A and 32B at the locations of the connecting blocks 34. Using multiple belts can increase the load bearing capacity of the drive assembly. Such an example may be particularly well-suited for use in a passenger conveyor having a relatively longer run, for example.

FIG. 10 shows another multiple belt example. The two belts 32A and 32B are side-by-side in this example (instead of being stacked together as in the example of FIG. 9). The greater width of the driving surface 44 in this example provides sufficient frictional engagement with both belts 32A and 32B.

In each of the examples of FIGS. 4 through 10, at least some of the surface of the belt 32 is exposed facing the exterior drive surface 44 on the drive wheel along the entire length of the belt 32. These examples provide for frictional driving engagement between the drive wheel 40 and the belt 32 wherever the belt 32 wraps about the drive wheel 40.

In the example of FIG. 11, the belt 32 has an at least partially V-shaped cross section and the drive surface 44 has a corresponding V-shaped configuration such that there is frictional engagement between three surfaces at the interface between the belt 32 and the drive surface 44.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-15. (canceled)

16. A drive assembly for a passenger conveyor, comprising:
a belt including a plurality of cords at least partially encased in a jacket; and
a plurality of connecting blocks secured to the belt longitudinally spaced apart from each other along the belt; and
a drive wheel for moving the belt, the drive wheel having a surface adapted to engage a corresponding surface on the connecting blocks such that the drive wheel moves the belt by positive engagement between the drive wheel and the connecting blocks.

17. The drive assembly of claim 16, wherein the connecting blocks each comprise a first portion received against a first side of the belt, a second portion received against a second, opposite side of the belt

18. The drive assembly of claim 17, wherein each of the connecting blocks comprises at least one securing member that secures the first and second portions against the respective side of the belt.

19. The drive assembly of claim 17, wherein each of the connecting blocks comprises two first portions near opposite edges of the belt such that a central portion of the belt on the first side is exposed between the two first portions.

20. The drive assembly of claim 19, wherein each of the connecting blocks comprises a single second portion associated with both of the first portions.

21. The drive assembly of claim 19, wherein each of the connecting blocks comprises two second portions and each of the second portions is associated with one of the two first portions.

22. The drive assembly of claim 16, wherein the belt has a generally rectangular exterior cross section.

23. The drive assembly of claim 16, wherein the belt has an exterior cross section that is at least partially generally V-shaped.

24. The drive assembly of claim 16, wherein at least some of the connecting blocks have a connector surface adapted to be connected to a step of an associated passenger conveyor.

25. The drive assembly of claim 16, wherein at least some of the connecting blocks have a connector surface adapted to be connected to a step axle of an associated passenger conveyor.

26. The drive assembly of claim 16, wherein the drive wheel comprises a surface that engages the belt at least along portions of the belt between the connecting blocks for moving the belt by frictional engagement between the drive wheel and the belt.

27. The drive assembly of claim 26, wherein a central portion of the belt on a side of the belt facing the drive wheel is exposed along an entire length of the belt and the central portion is frictionally engaged by the drive wheel.

28. The drive assembly of claim 16, wherein the drive wheel has an exterior surface with a plurality of recesses that are contoured to at least partially receive and drivingly engage the connecting blocks for moving the drive belt.

29. The drive assembly of claim 16, wherein
the cords comprise steel,
the jacket comprises urethane; and
the connecting blocks comprise a metal body with a polymer coating.

30. A drive assembly for a passenger conveyor, comprising:
a belt including a plurality of cords at least partially encased in a jacket; and
a plurality of connecting blocks secured to the belt longitudinally spaced apart from each other along the belt, at least some of the connecting blocks having a connector surface adapted to be connected to a step of an associated passenger conveyor.

31. A drive assembly for a passenger conveyor, comprising:
a belt including a plurality of cords at least partially encased in a jacket; and
a plurality of connecting blocks secured to the belt longitudinally spaced apart from each other along the belt, at least some of the connecting blocks having a connector surface adapted to be connected to a step axle of an associated passenger conveyor.
